(19) United States
(12) Patent Application Publication
(10) Pub. No.: US 2016/0039186 A1
(43) Pub. Date: Feb. 11, 2016

(54) Vapor Permeable and Liquid Impermeable Film and Carpet Pad Including Same

(71) Applicant: Bloomer Plastics, Inc., Bloomer, WI (US)

(72) Inventor: Rahul Sarda, Altoona, WI (US)

(21) Appl. No.: 14/806,292

(22) Filed: Jul. 22, 2015

Related U.S. Application Data
(60) Provisional application No. 62/033,892, filed on Aug. 6, 2014.

(51) Int. Cl. B32B 27/08; B32B 27/32; B32B 37/24; B32B 27/20; B32B 5/18; B29C 47/04; B32B 27/06; B32B 27/36

(52) U.S. Cl. CPC B32B 27/08; B32B 27/065; B32B 27/32; B32B 27/36; B32B 27/20; B32B 5/18; B29C 47/043; B32B 37/24; B32B 2250/03; B32B 2266/0278; B32B 2305/022; B32B 2471/02; B32B 2266/0207

(57) ABSTRACT

A carpet pad comprising a cushion comprising an upper surface and a lower surface; and a co-extruded barrier film comprising a first layer and a second layer, wherein the co-extruded film is disposed on the cushion such that the second layer is interposed between the first layer and the upper surface, the film comprises from about 50 wt % to about 70 wt % of the first layer and from about 30 wt % to about 50 wt % of the second layer, the first layer comprises at least about 80 wt % of a polymeric (e.g., resin) material, and the second layer comprises at least about 75 wt % of a polyolefin copolymer material.

### CROSS REFERENCE TO RELATED APPLICATION

This non-provisional application claims priority to U.S. provisional application No. 62/033,892, filed on Aug. 6, 2014. This document is hereby incorporated by reference in its entirety.

### TECHNICAL FIELD

This disclosure relates to a carpet pad for use under a carpet, and more specifically, relates to a carpet pad having a co-extruded barrier film that exhibits liquid impermeable and moisture vapor permeable properties.

### BACKGROUND

Carpet pads are generally installed under carpets or rugs to make the carpeted flooring surface feel soft and luxurious to those walking on it, as well as to prolong the life of the carpet by dampening the stresses of traffic and protecting the flooring materials under the carpet from liquid spills that penetrate the carpet. Cushion materials used for carpet pads are generally open structures within an inherent ability to absorb or transmit liquids. Liquid retained in the carpet pad and on the flooring material beneath it resulting from a spill onto the carpet, may give rise to mold or bacterial growth, causing the carpet pad to emit an unpleasant odor. Moisture retention in the cushion material from moisture passing upwardly from the floor can also result in mold or bacterial growth.

Known carpet pads have been developed that are impermeable to liquids (resistance to spills) and permeable to moisture vapor (breathability). Drawbacks of these known carpet pads are that they often puncture easily, such as when pressure is exerted by a homeowner attempting to spot clean a liquid spill on the carpet. Once the carpet pad is punctured, the liquid impermeable properties thereof are lost and liquid will undesirably pass into the cushion material. It is further known to utilize closed cell foams in the carpet pad to resist liquid spills even during spot cleaning or after a reasonable level of foot traffic. A drawback of closed cell foams is that while they may be impermeable to liquid spills from above, they are not able to transmit moisture vapor. Underlayments are further known to achieve both resistance to spills and breathability, however, the introduction of an additional underlayment separate from the carpet pad requires an additional installation step and additional materials increasing the cost.

### SUMMARY OF THE INVENTION

The present invention provides a carpet pad comprising a cushion comprising an upper surface and a lower surface; and a co-extruded barrier film comprising a first layer and a second layer, wherein the co-extruded film is disposed on the cushion such that the second layer is interposed between the first layer and the upper surface, the film comprises from about 50 wt % to about 70 wt % of the first layer and from about 30 wt % to about 50 wt % of the second layer, the first layer comprises at least about 80 wt % of a polymeric material, and the second layer comprises at least about 75 wt % of a polyolefin copolymer material.

In some embodiments, the polymeric material of the first layer comprises a copolyester material. For example, the copolyester material comprises polyether ester elastomer.

In some embodiments, the first layer further comprises a colorant. For example, the colorant comprises TiO₂. In some instances, the colorant comprises from about 60 wt % to about 80 wt % (e.g., from about 65 wt % to about 75 wt % or about 70 wt %) of TiO₂ in an copolyester (ethylene methyl acrylate) dispersion. In other examples, the first layer comprises about 20 wt % or less of the colorant.

In some embodiments, the first layer further comprises less than about 1 wt % of a fragrance, an antimicrobial agent, a free radical scavenger, a deodorizer, a slip agent, or the like, or any combination thereof.

In some embodiments, the polyolefin copolymer material of the second layer comprises ethylene methyl acrylate (EMA). For example; the second layer further comprises about 7.5 wt % or less (e.g., from about 4 wt % to about 6 wt %, or about 5 wt %) of an anti-blocking agent. In some examples, the anti-blocking agent comprises from about 45 wt % to about 55 wt % of talc.

In other embodiments, the second layer further comprises about 15 wt % or less (e.g., from about 8 wt % to about 12 wt % or about 10 wt %) of a colorant. In some examples, the colorant comprises TiO₂. For instance, the colorant comprises a dispersion of TiO₂ in a polyolefin copolymer. And, in some instances, the dispersion comprises from about 60 wt % to about 80 wt % (e.g., from about 65 wt % to about 75 wt % or about 70 wt %) of TiO₂ in a polyolefin copolymer.

In some embodiments, the cushion comprises a foam material. For example, the foam material comprises polyurethane, synthetic rubber foam, or any combination thereof. In other examples, the cushion comprises a plurality of foam pieces that are joined (e.g., adhered) together to form a unitary cushion.

In other embodiments, the cushion further comprises less than about 1 wt % of a fragrance, an antimicrobial agent, a free radical scavenger, deodorant, or any combination thereof.

Another aspect of the present invention provides a carpet pad comprising a cushion having an upper surface and a lower surface, the cushion formed from a foam material; a co-extruded barrier film comprising a first layer comprising a copolyester resin; a second layer comprising a polyolefin copolymer (e.g., an acrylate copolymer material), wherein the second layer of the film is substantially interposed between the first layer of the film and the upper surface of the cushion, and the second layer adheres the film to the upper surface of the cushion.

In some embodiments, the co-extruded barrier film comprises from about 50 wt % to about 70 wt % (e.g., from about 55 wt % to about 65 wt % or about 60 wt %) of the first layer.

In some embodiments, the first layer comprises at least about 80 wt % (e.g., from about 85 wt % to about 95 wt % or about 90 wt %) of the copolyester resin.

In some embodiments, the first layer comprises about 20 wt % or less (e.g., from about 5 wt % to about 15 wt % or about 10 wt %) of a colorant.

In some embodiments, the co-extruded barrier film comprises from about 30 wt % to about 50 wt % (e.g., from about 35 wt % to about 45 wt % or about 40 wt %) of the second layer.

In some embodiments, the second layer comprises about 15 wt % or less of a colorant.

In some embodiments, the second layer comprises about 7.5 wt % or less (e.g., from about 4 wt % to about 6 wt %) of an anti-blocking agent.

Another aspect of the present invention provides a method of producing a barrier film for a carpet pad comprising co-extruding a first material and a second material to form a film that comprises a first layer and a second layer, wherein the film comprises from about 50 wt % to about 70 wt % of the first layer and from about 30 wt % to about 50 wt % of the second layer; the first layer comprises at least about 80 wt % of a copolyester resin and about 20 wt % or less of a colorant; and the second layer comprises at least about 75 wt % of polyolefin copolymer material (e.g., an acrylate copolymer material), no more than about 7.5 wt % of an anti-blocking agent.

Some implementations comprise drying a feedstock for the first material to generate a feedstock that substantially free of water.

Other implementations comprise drying a feedstock for the second material to generate a feedstock that is substantially free of water.

In some embodiments, the polyolefin copolymer material (e.g., acrylate polymer material) comprises ethylene methyl acrylate.

Another aspect of the present invention provides a method of producing a carpet pad comprising co-extruding a first material and a second material to form a film that comprises a first layer and a second layer; and adhering the film to a cushion to generate the carpet pad, wherein the second layer is substantially disposed between the first layer and the cushion; the second layer adheres to the cushion and the first layer; the film comprises from about 50 wt % to about 70 wt % of the first layer and from about 30 wt % to about 50 wt % of the second layer; the first layer comprises at least about 80 wt % of a copolyester resin and about 20 wt % or less of a colorant; and the second layer comprises at least about 75 wt % of an acrylate polymer material, no more than about 7.5 wt % of an anti-blocking agent.

### BRIEF DESCRIPTION OF DRAWINGS

FIG. 1 is a schematic view of an example flooring environment including a carpet pad for use as an underlayment supporting a carpet.

FIG. 2 is a schematic view of a co-extruded barrier film of the carpet pad of FIG. 1 that exhibits liquid impermeable and moisture vapor permeable properties.

Like reference symbols in the various drawings indicate like elements.

These figures are presented by way of example and are not intended to limit the scope of the claimed invention.

### DETAILED DESCRIPTION

The present invention provides a carpet pad comprising a cushion and a co-extruded barrier film, wherein the barrier film is substantially impermeable to liquids and substantially permeable to gas or vapor.

### I. DEFINITIONS

As used herein, the term “cushion” refers to a pad or material that is substantially resilient yet deformable upon an application of a force to the material. Cushions include foam materials (open or closed cell foams), elastomeric material, combinations thereof, or the like.

As used herein, the term “surface” refers to a continuous set of points that has length and breadth but no thickness. For example, a surface includes the outside facing or exposed plane (linear or contoured) of a film, a layer, or a pad.

As used herein, the term “resin” refers to any of a class of nonvolatile, solid or semisolid organic substances prepared by polymerization of simple molecules. Examples of resins include polyethylene, polypropylene, copolymers thereof, and the like.

As used herein, the term “copolyester resin” refers to polyether ester elastomer. Examples of polyether ester elastomers include copolymers (e.g., block copolymers) having monomer structural units of —[R—O]— and —[R—C(O)—O]—, wherein each R is independently a C₁₋₆ alkyl group.

As used herein, the terms “polyolefin copolymer material” and “polyolefin copolymer” are used interchangeably to refer to any polymer material that comprises a polyolefin monomer and one or more additional polyolefin monomers or other monomers. Polyolefin copolymers can include, without limitation, acrylate copolymer materials.

As used herein, the terms “acrylate copolymer material” and “acrylate copolymer” are used interchangeably to refer to any polymer or copolymer comprising the monomeric unit

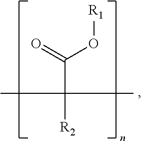

wherein each of R₁ and R₂ are independently selected from C₁₋₆ alkyl, and n is a non-zero positive integer. ‘Acrylate polymers’ also include any polymer or copolymer (e.g., block co-polymer, alternating copolymer, or the like) that is generated upon the polymerization of an acrylate monomer e.g.,

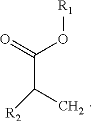

As used herein, the term “colorant” refers to a coloring agent (e.g., pigment) that functions to impart a material with a desired optical property.

As used herein, the term “fragrance” refers to an agent that imparts a material with a desired scent or olfactory response.

As used herein, the term “anti-microbial agent” refers to a compound or material that destroys or inhibits the growth of microorganisms (e.g., bacteria, fungi, viruses, combinations thereof, or the like).

As used herein, the term “free radical scavenger” refers to a molecule that inhibits the oxidation of other molecules by removing free radical intermediates, or otherwise inhibits oxidation reactions. Examples of free radical scavengers include reducing agents such as thiols, ascorbic acid, or polyphenols.

As used herein, the term “fibrous substrate” refers to any woven or non-woven fabric selected from the group consisting of: polyester, polyolefin, polyamide, poly(trimethylene terephthalate) synthetic fibers, natural fibers, bicomponent fiber, cellulosic fibers, wool, cotton, acrylic, jute and copolymers and blends thereof.

### II. CARPET PADS OF THE PRESENT INVENTION

One aspect of the present invention provides a carpet pad comprising a cushion comprising an upper surface and a lower surface; and a co-extruded barrier film comprising a first layer and a second layer, wherein the co-extruded film is disposed on the cushion such that the second layer is interposed between the first layer and the upper surface, the film comprises from about 50 wt % to about 70 wt % of the first layer and from about 30 wt % to about 50 wt % of the second layer, the first layer comprises at least about 80 wt % of a copolyester material, and the second layer comprises at least about 75 wt % of an acrylate copolymer material.

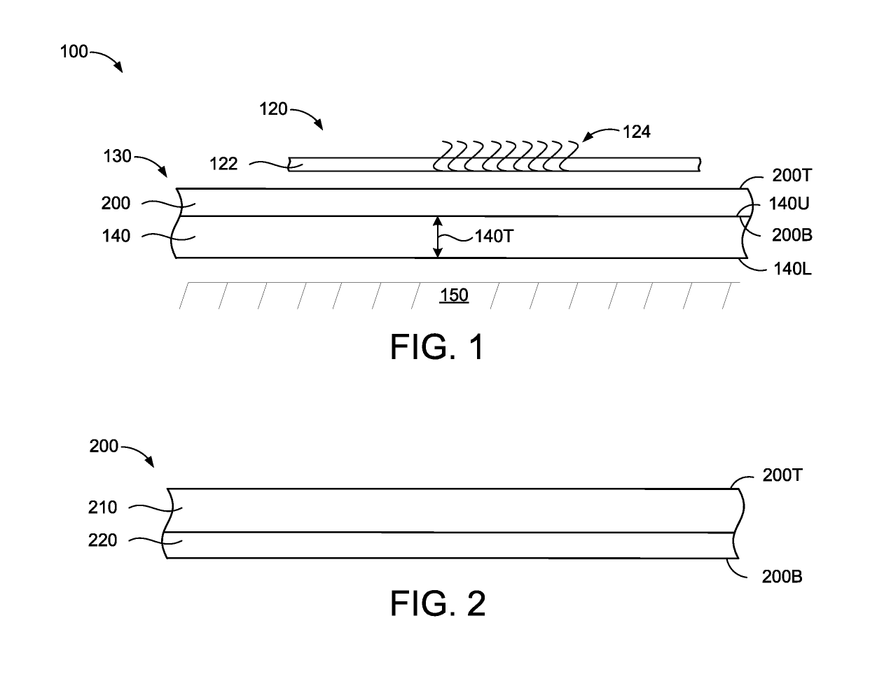

Referring to FIG. 1, in some embodiments, an example flooring environment 100 includes a carpet pad 130 for use as an underlayment supporting a carpet 120 disposed over a floor surface 150. For clarity, in the example shown, carpet pad 130 is depicted as being spaced slightly from both the carpet 120 and the floor surface 150.

The carpet 120 may be constructed in any manner. In some examples, the carpet 120 includes a pile face 124 formed by tufting fiber yarn into a backing 122. In the example shown, the pile face 124 may be in either cut or looped form. During installation, the carpet 120 is laid over the pad 130 such that the backing 120 contacts against the upper surface 200T of the carpet pad 130. The floor 150 may be formed of any material normally employed as a floor surface, such as wood, pressed board, cement, concrete vinyl, or acrylic polymer.

In the present invention, the carpet pad 130 includes a cushion 140 covered by a co-extruded barrier film 200. In the example shown, the cushion 140 includes upper and lower surfaces 140U, 140L, respectively, and the barrier film 200 includes top and bottom surfaces 200T, 200B, respectively. In these embodiments, the co-extruded barrier film comprises two layers, a first layer and a second layer, wherein the second layer of the film is interposed between the first layer of the film and the upper surface of the cushion. Thus, when the first layer and the second layer are co-extruded to form a unitary barrier film, the first layer comprises the top surface while the second layer comprises the bottom surface. In some examples, the second layer is formulated to adhere to the upper surface of the cushion under process conditions (e.g., ambient conditions and temperature, elevated temperature, elevated humidity, irradiation, elevated pressure, or any combination thereof).

The lower surface 140L of the cushion 140 may define an underside of the pad 130 that is presented to the floor 150 and the top surface 200T of the barrier film 200 defines the upper surface of the pad 130 that is presented to the carpet 120.

Embodiments herein are directed toward the carpet pad 130 being both substantially impermeable to liquid deposited onto the top surface of the barrier film (e.g., wetting caused by a liquid spill or animal wetting) and substantially permeable to vapor or other gas (e.g., organic solvents) diffusing in a direction from the floor or lower surface of the cushion through the upper surface of the cushion and exiting the top surface of the barrier film. As used herein, the terms “impermeable to liquid” and “liquid impermeable” are used interchangeably to refer to the property wherein a liquid is restricted from passing (e.g., diffusing) through a material (e.g., a barrier film) or being substantially absorbed by a material (e.g., a barrier film). For instance, a liquid impermeable co-extruded barrier film of one embodiment of the present invention does not substantially absorb one or more liquids (e.g., water, aqueous mixtures, organic liquids (e.g., grease, oil, or the like), or any combination thereof) and does not permit the liquid to substantially penetrate the film to contact the underlying cushion of the carpet pad. As used herein, the term “permeable to vapor” refers to the property wherein a gas (e.g., vapor) is capable of substantially diffusing through a material (e.g., through the second and first layers of the barrier film or through the carpet pad). The terms “permeable to moisture vapor”, “moisture vapor permeable”, “breathability” and “breathable” may be used interchangeably herein. In some examples, the co-extruded barrier film comprises a vapor transmission rate of at least about 13 (e.g., 14.6) grams per square meter per twenty-four hours (13 g/m²/24 hours). As a result, the example carpet pad 130 does not substantially absorb liquid deposited onto the top surface of the barrier film 200, and the carpet pad allows moisture or vapor to diffuse from the floor or cushion through the co-extruded barrier film.

The cushion 140 may be formed of a compressible and resilient material and comprise a thickness 140T that may be selected to be consistent with considerations of cost, comfort and aesthetics for a given installation. In some examples, the thickness of the cushion 140 lies in a range from about 0.125 inch to about two inches. In other examples, the cushion comprises a compressible and recoverable natural or synthetic material, or any combination thereof. For instance, naturally occurring materials can include jute and cotton while synthetic materials can include non-cellulosic materials such as polyurethane, polystyrene, or rubber continuous foams. In some examples, the cushion comprises one or more synthetic or natural materials (e.g., an agglomeration of polyurethane foam pieces generally known as “re-bond”). The cushion can optionally comprise additives (e.g., having a concentration of less than about 1 wt % by weight of the cushion) such as fragrance, a colorant, an anti-microbial agent, a free radical scavenger, any combination thereof, or the like.

The co-extruded barrier film 200, discussed in greater detail below with reference to FIG. 2, advantageously does not require the presence of any fibrous substrate laminated to any surfaces of the barrier film 200 (or the cushion 140). Accordingly, eliminating the fibrous substrate results in a reduced cost for the carpet pad. In some embodiments, one of the layers (e.g., first layer 210 of FIG. 2) of the barrier film 200 comprises a liquid impermeable material that is breathable (e.g., vapor or gas permeable) while simultaneously being sufficiently durable to withstand forces imposed during usage.

Referring to FIG. 2, in some embodiments, the co-extruded barrier film 200 comprises a first layer 210 and a second layer 220. In the example shown, the second layer 220 underlies the first layer 210. A top surface of the first layer 210 may comprise the top surface 200T of the co-extruded barrier film 200 and a bottom surface of the second layer 220 may comprise the bottom surface 220B of the co-extruded barrier film 200. In some embodiments, the co-extruded barrier film comprises from about 50 wt % to about 70 wt % (e.g., from about 55 wt % to about 65 wt % or about 60 wt %) of the first layer 210 by weight of the film. In other embodiments, the co-extruded barrier film comprises from about 30 wt % to about 50 wt % (e.g., from about 35 wt % to about 45 wt % or about 40 wt %) of the second layer 220 by weight of the film.

In some embodiments, the first layer 210 provides the aforementioned liquid impermeable and gas or vapor permeable properties exhibited by the carpet pad 130. The first layer 210 may include a liquid impermeable material composition that is sufficiently thin to be moisture or vapor permeable (e.g., breathable) while being both sufficiently resilient and sufficiently durable to withstand forces imposed during usage. For instance, the terms “resilient” and “durable” refer to the liquid impermeable material composition of the first layer 210 having a durability that resists rupture, tearing, yet it deforms and recovers repeatedly over its lifetime without substantially adversely affecting its impermeability to liquids (e.g., when pressure is exerted by normal foot traffic and/or when a homeowner is attempting to spot clean a liquid spill on the carpet) or its gas or vapor permeability. Advantageously, utilizing the liquid impermeable material composition to prohibit puncturing of the barrier film 200 avoids the occurrence of a liquid undesirably passing into the cushion material 140.

In some embodiments, the first layer comprises a polymeric material (e.g., a resin material). Suitable resins for the instant invention include, without limitation, polyester resins (e.g., polyester resin or polyester co-polymer resin (e.g., polyether ester thermoplastic)). In some examples, the first layer comprises at least 80 wt % (e.g., from about 80 wt % to about 99.9 wt %, from about 85 wt % to about 95 wt %, or about 90 wt %) of the polymeric material (e.g., resin material). In some embodiments, the first layer further comprises a colorant. For instance, the first layer comprises about 20 wt % or less (e.g., from about 5 wt % to about 15 wt %, from about 7.5 wt % to about 12.5 wt %, or about 10 wt %) of colorant. And, in some instances, the colorant comprises a white pigment. In other instances, the colorant comprises TiO₂. For example, the colorant comprises a dispersion of TiO₂ in the polymeric material (e.g., resin material (e.g., copolyester)). In other examples, the colorant comprises a dispersion comprising from about 60 wt % to about 80 wt % (e.g., from about 65 wt % to about 75 wt % or about 70 wt %) of TiO₂ in polymeric material (e.g., resin material (e.g., EMA)) by weight of the dispersion.

In other embodiments, first layer 210 comprises a copolyester resin. In other embodiments, the first layer comprises a blend of copolyester resin and colorant (e.g., white color concentrate). For example, the first layer comprises about 90 wt % copolyester resin and about 10% of colorant. In another embodiment, the first layer comprises a blend of copolyester resin, an anti-block agent and a colorant. For example, the first layer comprises about 85 wt % copolyester resin, about 5 wt % anti-block agent, and about 10% colorant. In some embodiments, the copolyester resin may comprise a polyether ester elastomer, such as Arnitel® EM550 available from DSM Engineering Plastics. In some embodiments, the colorant comprises TiO₂. For example, the colorant comprises a dispersion comprising from about 60 wt % to about 80 wt % (e.g., from about 65 wt % to about 75 wt % or about 70 wt %) of TiO₂ in copolyester by weight of the dispersion. In some embodiments, the anti-block agent comprises 50 wt % diatomaceous earth in a copolyester carrier. Anti-blocking agents useful for the first layer comprises powders or granules of material that do not substantially react with or dissolve in copolyester resin under coextrusion conditions.

In some embodiments, the second layer operatives as an adhesive that bonds the upper surface of the cushion to the bottom surface of the barrier film. The second layer 220 may comprise an adhesive material composition that does not materially add to the impermeability or durability of the pad; however, the adhesive material composition should not impede the moisture vapor permeability thereof.

In some embodiments, the second layer comprises a polyolefin copolymer material (e.g., an acrylate copolymer material). Suitable polyolefin copolymer materials for the instant invention include, without limitation, C₁₋₆ alkylene-methyl acrylate copolymer material. For example, the acrylate copolymer material comprises ethylene methyl acrylate copolymer material. In some examples, the second layer comprises at least 75 wt % (e.g., from about 75 wt % to about 99.9 wt %, from about 80 wt % to about 90 wt %, or about 85 wt %) of the acrylate copolymer material. In some embodiments, the second layer further comprises a colorant. For instance, the first layer comprises about 20 wt % or less (e.g., from about 5 wt % to about 15 wt %, from about 7.5 wt % to about 12.5 wt %, or about 10 wt %) of colorant. And, in some instances, the colorant is white. And, in some embodiments, the second layer further comprises an anti-blocking agent. In other embodiments, the anti-blocking agent comprises diatomaceous earth and a polymer carrier (e.g., about 50 wt % diatomaceous earth and about 50 wt % of EMA carrier). Anti-blocking agents useful for the second layer comprises powders or granules of material that do not substantially react with or dissolve in acrylate polymer materials under coextrusion conditions. In some instances, the second layer comprises no more than about 7.5 wt % (e.g., from about 2.5 wt % to about 7.5 wt % or about 5 wt %) of an anti-blocking agent.

In some embodiments, the co-extruded barrier film (e.g., the first layer, the second layer, or both layers) optionally comprise additives (e.g., having a concentration of less than about 1 wt % by weight of the film or weight of the layer) such as a fragrance, an anti-microbial agent, a free radical scavenger, any combination thereof, or the like.

### III. METHODS

Another aspect of the present invention provides a method of producing a barrier film for a carpet pad comprising co-extruding a first material and a second material to form a film (e.g., a unitary film) that comprises a first layer and a second layer, wherein the film comprises from about 50 wt % to about 70 wt % (e.g., from about 55 wt % to about 65 wt % or about 60 wt %) of the first layer and from about 30 wt % to about 50 wt % (e.g., from about 35 wt % to about 45 wt % or about 40 wt %) of the second layer; the first layer comprises at least about 80 wt % of a copolyester resin and about 20 wt % or less (e.g., from about 5 wt % to about 15 wt %, from about 7.5 wt % to about 12.5 wt %, or about 10 wt %) of a colorant; and the second layer comprises at least about 75 wt % (of an acrylate polymer material, no more than about 7.5 wt % of an anti-blocking agent.

Some implementations comprise drying a feedstock for the first material to generate a feedstock that is substantially free of water.

Other implementations comprise drying a feedstock for the second material to generate a feedstock that is substantially free of water.

In some implementations, the polyolefin copolymer material is an acrylate polymer material or an acrylate copolymer material. For instance, the polyolefin copolymer material comprises ethylene methyl acrylate (EMA).

Another aspect of the present invention provides a method of producing a carpet pad comprising co-extruding a first material and a second material to form a film that comprises a first layer and a second layer; and adhering the film to a cushion to generate the carpet pad, wherein the second layer is substantially disposed between the first layer and the cushion; the second layer adheres to the cushion and the first layer; the film comprises from about 50 wt % to about 70 wt % of the first layer and from about 30 wt % to about 50 wt % of the second layer; the first layer comprises at least about 80 wt % (e.g., from about 85 wt % to about 95 wt % or about 90 wt %) of a copolyester resin and about 20 wt % or less (from about 5 wt % to about 15 wt % or about 10 wt %) of a colorant; and the second layer comprises at least about 75 wt % (e.g., from about 80 wt % to about 90 wt % or about 85 wt %) of a polyolefin copolymer material (e.g., an acrylate copolymer material), no more than about 7.5 wt % (e.g., from about 2.5 wt % to about 7.5 wt % or about 5 wt %) of an anti-blocking agent.

Some implementations herein are directed toward forming the co-extruded barrier film using a two-layer co-extrusion line. The co-extrusion line may include two single screw extruders, a feedblock, and a die. In some examples, the two single-screw extruders may include a first extruder A having a first diameter and a second extruder B having a second different diameter. For instance, the first extruder A may include a 3.5 inch diameter and the second extruder A may include a 4.5 inch diameter. In some examples, a length to diameter ratio for each of the extruders is 24:1. In some embodiments, the first extruder A receives raw materials corresponding to the liquid impermeable material composition of the first layer 210 and the second extruder B receives raw materials corresponding to the adhesive material composition of the second layer 220. In some examples, the flow of raw materials received by each of the extruders A and B may be metered by a corresponding continuous gravimetric blender. The feedblock may receive the extruded materials from each of the extruders A and B and combine the extruded materials to produce the two-layer co-extruded structure of the barrier film 200 that includes the first and second layers 210,220, respectively, upon passing through the die. In some examples, the die includes a 103 inch wide coat-hanger die with automatic profile control.

Some implementations further comprise embossing the barrier film (e.g., using a set of steel and rubber rolls on an embossing table). In some examples, the barrier film 200 is treated to improve printability and adhesion to the cushion 140 when the material of the cushion 140 is foam. Processes such as drying and other steps may be carried out for the raw materials before being fed into the extruders to reduce processing issues attributed to moisture in the raw materials.

### IV. EXAMPLES

### Example 1

### Co-Extruded Barrier Film

A co-extruded two-layered film was generated as described below.

Co-Extruder

Films tested below were generated using a two-layer co-extrusion line. The co-extrusion line included two single screw extruders, a feedblock and a die. The two single-screw extruders included a first extruder having a 3.5 inch diameter and a second extruder having a 4.5 inch diameter. The length to diameter ratio for each of the extruders was 24:1.

Feedstock

The second layer of the film was co-extruded from a feedstock, wherein the feedstock was a substantially uniform blend of about 85 wt % EMA copolymer resin (EMAC® SP2205 Specialty Copolymer available from Westlake Chemical Co.), about 5 wt % of anti-block agent (50 wt % talc), and about 10 wt % of a blend of TiO₂ in the EMA copolymer resin (70 wt % TiO₂ and 30 wt % EMA)

The first layer of the film was co-extruded from a feedstock, wherein the feedstock was a substantially uniform blend of about 85 wt % polyether ester elastomer resin (Arnitel® EM550 available from DSM Engineering Plastics) and about 10 wt % of a blend of TiO₂ in the EMA copolymer resin (70 wt % TiO₂ and 30 wt % EMA) and 5 wt % of anti-block agent (50 wt % diatomaceous earth and 50 wt % EMA).

Process Conditions

During co-extrusion, the first extruder operated at a speed of about 55 RPM and the second extruder operated at a speed of about 20 RPM. The first extruder employed four barrel zones, wherein the temperature of the first barrel zone was about 405° F., the temperature of the second barrel zone was about 435° F., the temperature of the third barrel zone was about 455° F., and the temperature of the fourth barrel zone was about 465° F. The second extruder employed five barrel zones, wherein the temperature of the first barrel zone was about 415° F., the temperature of the second barrel zone was about 445° F., the temperature of the third barrel zone was about 465° F., the temperature of the fourth barrel zone was about 465° F., and the temperature of the fifth barrel zone was about 465° F. A changer for the feedblock and the feedblock and output piping operated at a temperature of about 455° F. The temperature at the die was from about 460° F. to about 480°. The resulting co-extruded film was embossed to have an embossed thickness of about 4.4 mil.

### Example 2

### Comparative Assessment of Physical and Optical Properties

The co-extruded film generated as described in Example 1 above was tested against a control film of butylene/poly (alkylene ether) phthalate copolymer available from E.I. du Pont de Nemours and Company, under the trade name Hytrel®, having an embossed thickness of about 2.7 mil. The physical property tests included Elmendorf Tear, Tensile Stress, Elongation and Opacity tests for the film of Example 1 and the control film. As used herein, the terms “MD” and “TD”, for the physical property tests, refer to machine direction and transverse direction, respectively. Results for each of the physical property tests are shown below in Table 1.

TABLE 1

| | Barrier Film of | |
|---|---|---|
| Property | Example No. 1 | Hytrel ® |
| Yield (mil) | 1.4 | 1.3 |
| Embossed Thickness (mil) | 4.4 | 2.7 |
| MD Elongation (%) | 587 | 553 |
| TD Elongation (%) | 605 | 501 |
| MD Tensile Stress (lbf) | 6.5 | 3.7 |
| TD Tensile Stress (lbf) | 5.1 | 4.2 |
| MD Elmendorf Tear (g-f) | 108 | 101 |
| TD Elmendorf Tear (g-f) | 457 | 51 |
| X-Rite Opacity (DEN) | 0.28 | .20 |

The measurements for the MD and TD Elongation tests were obtained using the international Standard Test Method for Tensile Properties of Thin Plastic Sheeting, ATSM D882-02. Elongation indicates a magnitude of strain the films can experience before failure in tensile testing. In Table 1, the MD and TD Elongation values of 587% and 605%, respectively, for the barrier film of Example 1 are both greater than the corresponding values of 553% and 501%, respectively, for Hytrel.

The measurements for the MD and TD Tensile Stress tests were also obtained using ATSM D882-02. The tensile stress results are measured in units of pound force. Tensile Stress indicates the measure of force at failure in the barrier films. In Table 1, the MD and TD Tensile Stress values of 6.5 lbf and 5.1 lbf, respectively, for the film of Example 1, are both greater than the corresponding values of 3.7 lbf and 4.2 lbf, respectively, for Hytrel.

The measurements for the MD and TD Elmendorf Tear tests were obtained using the international Standard Test Method for Propagation Tear Resistance of Plastic Film and thin Sheeting by Pendulum Method, ATSM D1922-00a. The results for the Elmendorf Tear test are measured in grams-force (g-f). Thus, the Elmendorf Tear test indicates the force necessary to propagate a tear in the barrier films. In Table 1, the MD Elmendorf Tear value of 108 g-f for the film of Example 1 is slightly greater than the corresponding value of 101 g-f for Hytrel. However, the TD Elmendorf Tear value of 457 g-f for the film of Example 1 exceeds the corresponding value of 51 g-f for Hytrel. Accordingly, a comparison of the results for the Elmendorf Tear, Tensile Stress, Elongation tests shown in Table 1 demonstrate that an exemplary two-layer co-extruded barrier film of the present invention possesses greater durability and is more puncture resistance compared to a known butylene/poly(alkylene ether) phthalate copolymer barrier film, i.e., Hytrel.

The measurements for the Opacity test (i.e., transmission densitometry) were obtained using an X-Rite Opacity meter (Model 341C; Serial Number 110055). Accordingly, the measurements are in units of transmission density (DEN), wherein DEN=log₁₀(1/% T), and % T is percent transmittance. In Table 1, the X-Rite Opacity test value of 0.28 DEN for the film of Example 1 is greater than the corresponding value of 0.20 DEN for Hytrel. Thus, the increased opacity of the exemplary two-layer co-extruded barrier film of Example 1 offers an improved print surface compared to a butylene/poly(alkylene ether)phthalate copolymer barrier film, such as Hytrel.

### Other Embodiments

All publications and patents referred to in this disclosure are incorporated herein by reference to the same extent as if each individual publication or patent application were specifically and individually indicated to be incorporated by reference. Should the meaning of the terms in any of the patents or publications incorporated by reference conflict with the meaning of the terms used in this disclosure, the meaning of the terms in this disclosure are intended to be controlling. Furthermore, the foregoing discussion discloses and describes merely example embodiments of the present invention. One skilled in the art will readily recognize from such discussion and from the accompanying drawings and claims, that various changes, modifications and variations may be made therein without departing from the spirit and scope of the invention as defined in the following claims.

What is claimed is:

1. A carpet pad comprising:
a cushion comprising an upper surface and a lower surface; and
a co-extruded barrier film comprising a first layer and a second layer,
wherein the co-extruded film is disposed on the cushion such that the second layer is interposed between the first layer and the upper surface, the film comprises from about 50 wt % to about 70 wt % of the first layer and from about 30 wt % to about 50 wt % of the second layer, the first layer comprises at least about 80 wt % of a copolyester material, and the second layer comprises at least about 75 wt % of a polyolefin copolymer material.

2. The carpet pad of claim 1, wherein the copolyester material of the first layer comprises a polyether ester elastomer.

3. The carpet pad of claim 2, wherein the first layer further comprises a colorant comprising a dispersion of TiO₂ in the copolyester material.

4. The carpet pad of claim 3, wherein the dispersion comprises from about 60 wt % to about 80 wt % of TiO₂.

5. The carpet pad of claim 3, wherein the first layer comprises about 20 wt % or less of the colorant.

6. The carpet pad of claim 2, wherein the first layer comprises an anti-blocking agent.

7. The carpet pad of claim 6, wherein the first layer comprises about 7.5 wt % or less of the anti-blocking agent.

8. The carpet pad of claim 7, wherein the anti-blocking agent comprises a dispersion comprising from about 45 wt % to about 55 wt % of diatomaceous earth in EMA.

9. The carpet pad of claim 8, wherein the first layer further comprises less than about 1 wt % of a fragrance, an antimicrobial agent, a free radical scavenger, deodorant, or any combination thereof.

10. The carpet pad of claim 1, wherein the polyolefin copolymer material of the second layer comprises C₁₋₆ alkylene methyl acrylate.

11. The carpet pad of claim 10, wherein the second layer further comprises about 7.5 wt % or less of an anti-blocking agent.

12. The carpet pad of claim 11, wherein the anti-blocking agent comprises a dispersion of from about 45 wt % to about 55 wt % of talc in the polyolefin copolymer material.

13. The carped pad of claim 7, wherein the second layer further comprises about 15 wt % or less of a colorant.

14. The carpet pad of claim 13, wherein the second layer further comprises a colorant comprising a dispersion of TiO₂ in polyolefin copolymer material.

15. The carpet pad of claim 14, wherein the dispersion comprises from about 60 wt % to about 80 wt % of TiO₂.

16. The carpet pad of claim 1, wherein the cushion comprises a foam material.

17. The carpet pad of claim 16, wherein the foam material comprises polyurethane, synthetic rubber foam, or any combination thereof.

18. The carpet pad of claim 1, wherein the cushion further comprises less than about 1 wt % of a fragrance, an antimicrobial agent, a free radical scavenger, or any combination thereof.

19. A carpet pad comprising:
a cushion having an upper surface and a lower surface, the cushion formed from a foam material;
a co-extruded barrier film comprising:
a first layer comprising a copolyester resin;
a second layer comprising a polyolefin copolymer material,
wherein the second layer of the film is substantially interposed between the first layer of the film and the upper surface of the cushion, and the second layer adheres the film to the upper surface of the cushion.

20. The carpet pad of claim 19, wherein the co-extruded barrier film comprises from about 50 wt % to about 70 wt % of the first layer.

21. The carpet pad of claim 20, wherein the first layer comprises from at least about 80 wt % of the copolyester resin.

22. The carpet pad of claim 21, wherein the first layer comprises about 20 wt % or less of a colorant.

23. The carpet pad of claim 19, wherein the co-extruded barrier film comprises from about 30 wt % to about 50 wt % of the second layer.

24. The carpet pad of claim 23, wherein the second layer comprises about 15 wt % or less of a colorant.

25. The carpet pad of claim 24, wherein the second layer comprises about 7.5 wt % or less of an anti-blocking agent.

26. A method of producing a barrier film for a carpet pad comprising:
co-extruding a first material and a second material to form a film that comprises a first layer and a second layer,
wherein the film comprises from about 50 wt % to about 70 wt % of the first layer and from about 30 wt % to about 50 wt % of the second layer; the first layer comprises at least about 80 wt % of a copolyester resin and about 20 wt % or less of a colorant; and the second layer comprises at least about 75 wt % of a polyolefin copolymer material, no more than about 7.5 wt % of an anti-blocking agent.

27. The method of claim 26, further comprising drying a feedstock for the first material to generate a feedstock that substantially free of water.

28. The method of claim 27, further comprising drying a feedstock for the second material to generate a feedstock that substantially free of water.

29. The method of claim 26, wherein the acrylate polymer material comprises ethylene methyl acrylate.

30. A method of producing a carpet pad comprising:
co-extruding a first material and a second material to form a film that comprises a first layer and a second layer; and
adhering the film to a cushion to generate the carpet pad,
wherein the second layer is substantially disposed between the first layer and the cushion; the second layer adheres to the cushion and the first layer; the film comprises from about 50 wt % to about 70 wt % of the first layer and from about 30 wt % to about 50 wt % of the second layer; the first layer comprises at least about 80 wt % of a copolyester resin and about 20 wt % or less of a colorant; and the second layer comprises at least about 75 wt % of a polyolefin copolymer material, no more than about 7.5 wt % of an anti-blocking agent.
